(19) United States
(12) Patent Application Publication
(10) Pub. No.: US 2013/0334886 A1
(43) Pub. Date: Dec. 19, 2013

(54) Distributed Power Station System

(71) Applicant: Lei Qu, Suzhou City (CN)

(72) Inventor: Lei Qu, Suzhou City (CN)

(73) Assignee: Suzhou Gaia Intelligence Technology Co., Ltd, Suzhou City, Jiangsu (CN)

(21) Appl. No.: 14/002,254

(22) PCT Filed: Mar. 2, 2012
(86) PCT No.: PCT/CN12/71843

§ 371 Date: Aug. 29, 2013

(30) Foreign Application Priority Data
Mar. 3, 2011 (CN) 20111051627.6

(51) Int. Cl. H02J 3/04

(52) U.S. Cl. CPC H02J 3/04
USPC 307/69

(57) ABSTRACT

A distributed power station system, comprising a remote control/management system (1), a plurality of individual power-generating units (21-2n) distributed in a freely-spaced manner, and a power line (3) connecting to all of the power-generating units and concentrating the electrical energy therefrom into the control/management system. Each power-generating unit comprises at least one set of power-source unit (211, 221, 231, 241) and one power-source-unit controller (212), each set consists of one power-source unit and one power-source-unit controller. Said power-source-unit controller is connected between the power line and the output end of the power-source unit, said output end facing the power line. Said power-source unit is an energy collection-and-conversion device comprising at least one of types of wind power, aerodynamic power, photovoltaic power, methane power, geothermal power, hydraulic power, and thermoelectric power. The power-source-unit controller and the power line implement the power transmission, which especially allows for new energy sources to be widely deployed in economically developed regions, and greatly reduces the loss in the power-source system as well as the investment and loss in transmission lines, thereby offering a high utilization rate and improving system redundancy. The implementation of the present invention will greatly speed up the widespread use of new energy.

### TECHNICAL FIELD

The present invention relates to a new pattern of energy utilization, especially relates to a power station planning and architecture adopting flexible land occupancy strategy and multiple forms of power-source unit to generate electricity.

### BACKGROUND ART

Along with the increasingly scarcity of the earth resources, the investment cost of basic-energy climbs unceasingly, and various kinds of hidden pollution problems and safety problems exist ubiquitously. As an inexhaustible safe and environmental friendly energy, the renewable energy, such as wind energy, solar energy, hydraulic power and so on, is receiving increasingly wide attention. However, at present, renewable energies including wind, solar and other renewable energies are mainly limited to large plant applications and these energy resources usually distribute geographically far away from economically developed regions having greater energy demands. Even if the energy resources distribute geographically close to economically developed regions, at where the price of land utilization is so expensive, the feasibility of constructing large power plants is not high because of large land occupancy and huge capital investment.

Meanwhile, the electricity directly generated from some new energies is direct current, in the existing new energy grid-connected system, the direct current should be converted to alternating current, in order that the new energy system is connected into the AC power grid. However, due to such processes, the power loss is increased because of current conversion, and on the other hand, since the AC grid-connected device is so expensive that it is only suitable for the new energy system with larger power, usually there is no feasibility of grid-connection unless the new energy system has more than 3 KW of power.

These two problems mentioned above greatly limited the large-scale development of new energy. The situation that the grid infrastructure is poor and cannot adapt to the volatile new energy power and further limits the utilization of new energy.

### SUMMARY OF THE INVENTION

In view of the above mentioned defects existing in the prior art, it is an object of the present invention to provide an distributed power station system, using a variety of renewable energies as energy sources, to adapt to all scales of energy systems and power transmission systems, meanwhile it can take advantage of various existing installation conditions and support the interconnection among systems in different scales.

The object of the present invention is achieved by the following technical solution:

A distributed power station system comprises a remote control/management system, a plurality of individual power-generating units distributed in a freely-spaced manner, and a power line connecting all of the power-generating units and concentrating the electrical energy therefrom into the control/management system, each individual power-generating unit comprises at least one set of power-source unit and power-source-unit controller, each set consists of one power-source unit and one power-source-unit controller, wherein said power-source-unit controller is connected between the power line and an output end of the power-source unit, said output end facing the power line, and said power-source unit is an energy collection-and-conversion device comprising at least one of types of wind power, aerodynamic power, photovoltaic power, methane power, geothermal power, hydraulic power, and thermoelectric power, or any combination thereof.

Preferably, power-source units comprised in all the individual power-generating units connected to the power line are of the same type, and the distributed power system is a single type energy conversion power generating system; alternatively, power-source units comprised in all the individual power-generating units connected to the power line are not of the same type, and the distributed power system is a multi-type energy conversion power generating system.

Preferably, said power line is a direct current transmission line.

Preferably, said power-source-unit controller comprises at least an output control module for preventing energy from back flowing on the power line to corresponding power-generating unit; and said power-source-unit controller further comprises one of a rectifying/voltage conversion module and a power tracking control module, or a combination thereof.

Further preferably, said power-source-unit controller further comprises a microprocessor based intelligent control module, connecting respectively with an output node of the power-source unit, an output node of the power-source-unit controller and control nodes of every modules. And said power-source-unit controller further includes a communication module on the basis of the intelligent control module, and the communication module intercommunicates with the control/management system.

Preferably, said control/management system is connected with an electrical energy storage device and a span grid-connecting device, the electrical energy storage device and the span grid-connecting device are used respectively for storage and transmission management of the electrical energy transmitted from the power line; and said control/management system is connected to other existing large-scale power generation systems to establish a larger area energy application system.

Preferably, said power-generating units with a photovoltaic power-source unit or a wind-photovoltaic integrated power-source unit are distributed freely-spaced along both sides of urban roads and on clearing fields.

With the application of the distributed power station system of the present invention, the existing problems of new energy promotion would be solved, which especially allows for new energy sources to be widely deployed in economically developed regions, and greatly reduces the loss in the power-source system as well as the investment and loss in transmission lines, thereby offering a high utilization rate and improving system redundancy. The implementation of the present invention will greatly speed up the widespread use of new energy.

### BRIEF DESCRIPTION OF THE DRAWINGS

FIG. 1 is a schematic diagram illustrating the topology structure of the distributed power station system of the present invention;

FIGS. 2a-2e respectively are configuration structure diagrams of power-source-unit controllers of individual power-generating units in the distributed power station system of the present invention, wherein the power-source-unit controllers are configured according to different application requirements;

FIG. 3 is a schematic diagram illustrating the external connections of the control/management system of the distributed power station system of the present invention.

### DETAILED DESCRIPTION OF THE PREFERRED EMBODIMENTS

The preferred embodiments of the present invention will be described in more details with reference to the accompanying drawings so that the technical solutions of the present invention will be understood and employed more easily.

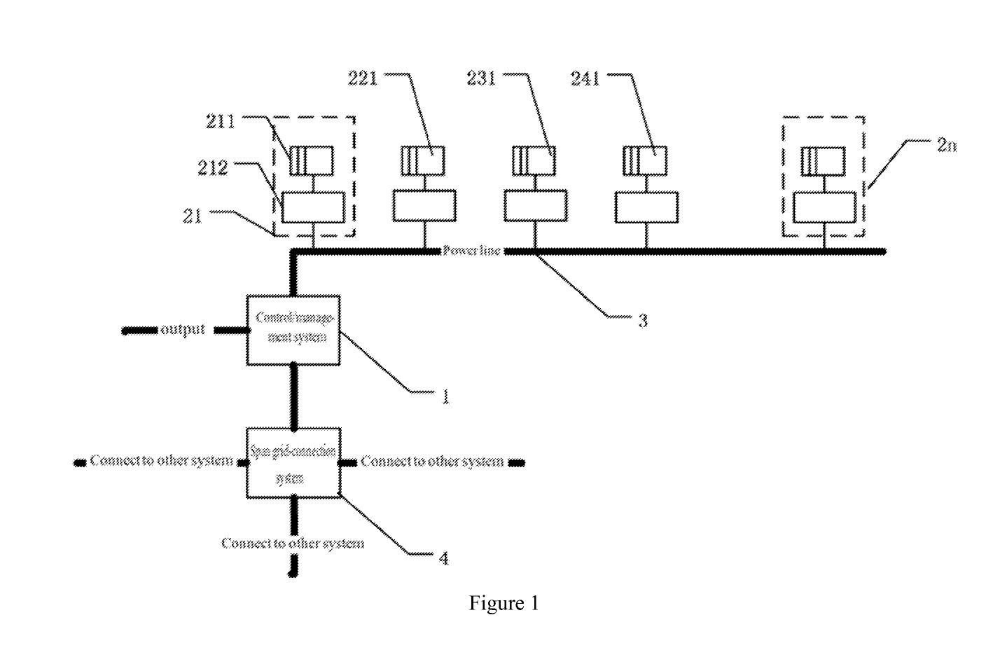

As shown in the schematic diagram of the topology structure in FIG. 1, the distributed power station system designed in the present invention comprises a control/management system, and a plurality of individual power-generating units distributed in a freely-spaced manner and connected to a power line. However in practical applications, said power line could consist of many power lines interlacing with each other (not shown). As shown in the figures, said system comprises all scales and forms of individual power-generating units distributed everywhere, a power line connecting the individual power-generating units, a control/management system and grid-connecting devices and wires spanning among different systems, and so on.

The fundamental core framework of the present invention comprises the control/management system 1, the power line 3 and a number of individual distributed power-generating units 21-2n consisted of power-source units and power-source-unit controllers. The system power line adopts direct current power transmission, since most kinds of renewable energies directly generate direct current, even if alternating current is generated, it still needs to be converted into direct current for transmission. Since synchronous equipment is no longer required, the investment is reduced greatly, and the power-source unit with less investment also has the feasibility of grid-connection.

Taking the individual power-generating unit 21 as an example, it comprises a wind power-source unit 211 and a power-source-unit controller 212. Various kinds of energies are collected by power-source units and converted into electrical energy. The energy sources herein are diversified and all natural forms of renewable energies capable of being converted into electrical energy are applicable. The power-source units are energy collection-and-conversion devices comprising at least one of types of wind power, aerodynamic power, photovoltaic power, methane power, geothermal power, hydraulic power, and thermoelectric power, or any combination thereof, namely that the wind power-source unit 211, photovoltaic power-source unit 221, geothermal power-source unit 223 and thermoelectric power-source unit 224, and the like, could be operated simultaneously on the same power line. Wherein, the aerodynamic power is a kind of energy utilization manner different from the wind power. Even under windless condition, the aerodynamic power could utilize natural energy effectively and rationally because of stack effect. And the working status of respective power-source units in individual power-generating units are controlled and managed, such as conversion control, voltage regulating, monitoring and protecting, and so on, by corresponding power-source-unit controllers. The converted and regulated electrical energy is transmitted through the respective individual power-generating unit to the power line, and electrical energy from all the individual power-generating units is concentrated and transmitted into the control/management system via the power line.

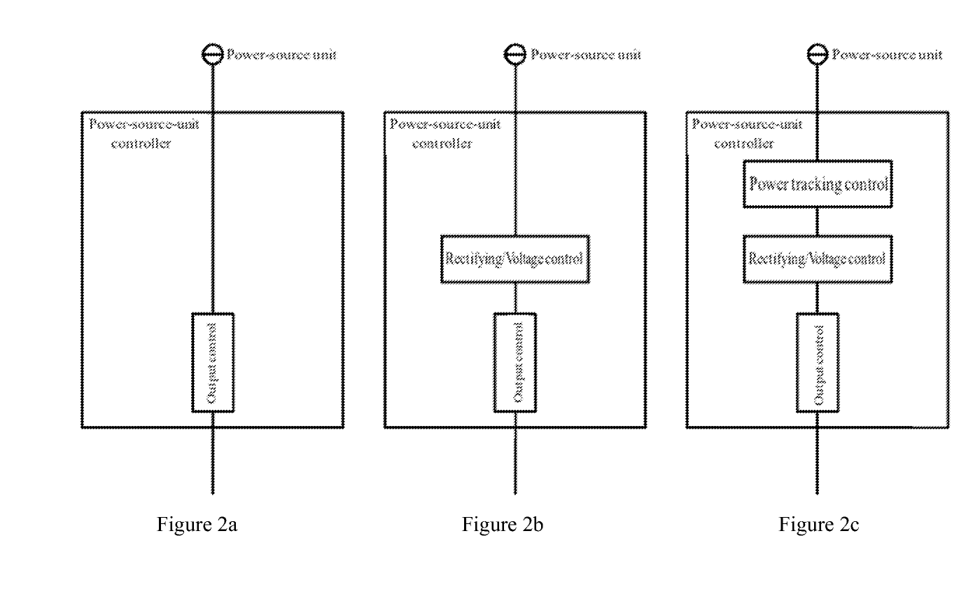

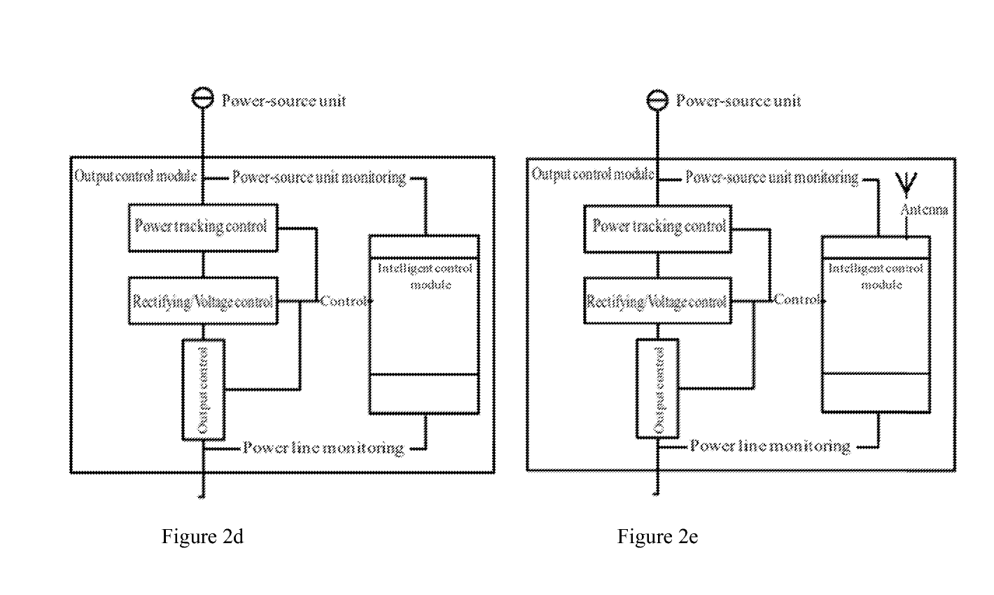

With respect to a power-source unit with alternating current output manner, the power-source-unit controller thereof would implement electricity conversion, such as rectifying, filtering and so on. At the same time, said power-source-unit controller has functions of controlling, monitoring and protecting the power-source unit. The structure of power-source-unit controller is allowed to have different forms according to different application requirements. As shown in FIGS. 2a to 2c, three kinds of power-source-unit controllers are provided according to different application requirements. In fact, as an interface between the power-source unit and the power line, the power-source-unit controller has the most basic function of preventing energy backflow. Therefore, the most simple form of the power-source-unit controller is a diode used for preventing current backflow (as shown in FIG. 2a). However, if only one diode is used in a larger and complex system, the efficiency will be reduced, and the management effect will not be good either. So, said power-source-unit controller can be further integrated with rectifying/voltage conversion module or power tracking control module.

For adapting to different requirements of performance and efficiency, more embodiments would be possible. In the present invention, the control/management system is a remote system and the individual power-source units are distributed in different positions, so the system uses the power-source-unit controller to realize the functions of controlling, monitoring and managing the distributed power-source units.

As shown in FIGS. 2d and 2e, the efficiency and reliability of the power-source unit would be improved more effectively by using a microprocessor-based intelligent control module to monitor and control every component of the control output module.

The power-source-unit controller can obtain the working status and health status of the power-source unit by means of detecting every parameters of the power-generating unit, and control the working status of the power-generating unit by means of one or several kinds of system networking technologies (e.g., trunk line sharing status recognition, carrier wave communication, wireless communication, and so on). The system may upload the working status and health status of the individual power-generating units to the control/management system, and then said individual power-generating units could be managed, controlled and maintained in system level by the control/management system.

On the basis of the intelligent control module, a communication module is further added, such as a wireless, infrared, GSM, GPRS or 3G module, or a module making use of the power line carrier, and so on, to intercommunicate with the control/management system in direct or cascade manner, so as to report the status of the individual power-generating unit and accept the control of the system.

The electrical energy transmitted from the power line is managed (stored, transmitted, and the like) by the control/management system. At the same time, the control/management system is connected to other systems through span grid-connecting devices, so as to constitute a wider area of energy system.

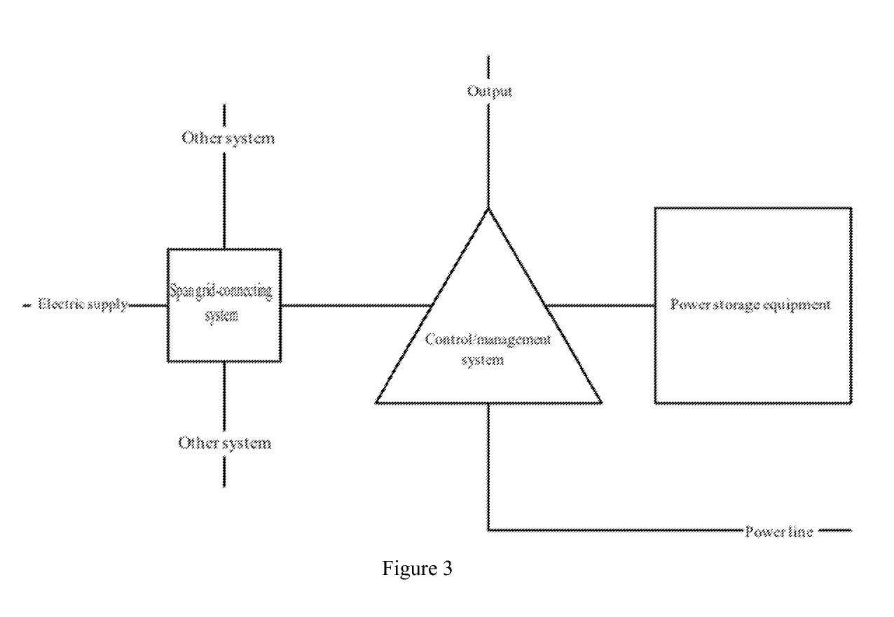

The electrical energy transmitted from the power line is received by the control/management system, and then transmitted to electricity consuming systems or devices through output lines. When the electrical energy transmitted from the power line is beyond the need of the electricity consuming systems or devices, the extra electrical energy could be transmitted through span grid-connecting devices to other systems like the normal power system, or be stored by power storage equipment (as shown in FIG. 3). Whereas when the electrical energy transmitted from the power line is less than the need of the electricity consuming systems or devices, the shortage part of the electrical energy could be supplied from the normal power system through span grid-connecting devices or be supplied from the power storage equipment.

In view of the embodiments of the present invention: a variety of streetlights, dustbins, road signs, street billboards, public washrooms, kiosks and so on are widely distributed on the street of large and medium sized cities, and these existing infrastructures provide support for establishing the distributed power station system of the present invention. It is easy to set wind power systems on the existing solar power streetlights, and as a matter of fact, such applications, like setting solar energy collection/conversion devices on infrastructures, such as dustbins, billboards, road signs, public washrooms, kiosks and so on, or setting hydraulic power devices in the sewer, could be implemented on a large area easily in developed regions. Although the energy converted by one individual power-generating unit is little, it is huge after concentrating the energy from the individual power-generating units distributed in a freely-spaced manner on a large area.

Meanwhile, more powerful renewable power stations could be deployed on large buildings, for example, the rooftop solar power station, the exterior facade power station and so on. And then, by simply adjusting the existing power lines with manners foregoing, the distributed power station system of the present invention can realize complementary with these more powerful power-source units, or normal power system, or other scales and forms of power systems.

It can be seen that, with the distributed power station system of the present invention, various non-equilibrant natural energy sources distributed in a freely-spaced manner could be fully utilized to integrate into a new energy which can to be widely deployed in economically developed regions where the cost of land utilization is relatively more expensive. The distributed power station system of the present invention, as a good auxiliary of the normal power system of cities, can greatly speed up the widespread use of new energy.

What is claimed is:

1. A distributed power station system, comprising a remote control/management system, a plurality of individual power-generating units distributed in a freely-spaced manner, and a power line connecting all of the power-generating units and concentrating the electrical energy therefrom into the control/management system; each individual power-generating unit comprises at least one set of power-source unit and power-source-unit controller, each set consists of one power-source unit and one power-source-unit controller; wherein said power-source unit is an energy collection-and-conversion device comprising at least one of types of wind power, aerodynamic power, photovoltaic power, methane power, geothermal power, hydraulic power, and thermoelectric power, or any combination thereof; and wherein said power-source-unit controller is connected between the power line and an output end of the power-source unit, said output end facing the power line; said power-source-unit controller comprises at least an output control module for preventing energy from back flowing on the power line to corresponding power-generating unit, comprises one of a rectifying/voltage conversion module and a power tracking control module, or a combination thereof, and comprises a microprocessor based intelligent control module, connecting respectively with an output node of the power-source unit, an output node of the power-source-unit controller and control nodes of every modules.

2. The power station system according to claim 1, wherein, power-source units comprised in all the individual power-generating units connected to the power line are of the same type, and the distributed power system is a single type energy conversion power generating system.

3. The power station system according to claim 1, wherein, power-source units comprised in all the individual power-generating units connected to the power line are not of the same type, and the distributed power system is a multi-type energy conversion power generating system.

4. The power station system according to claim 1, wherein, said power line is a direct current transmission line.

5.-7. (canceled)

8. The power station system according to claim 1, wherein, said power-source-unit controller further includes a communication module on the basis of the intelligent control module, and the communication module intercommunicates with the control/management system.

9. The power station system according to claim 1, wherein, said control/management system is connected with an electrical energy storage device and a span grid-connecting device, the electrical energy storage device and the span grid-connecting device are used respectively for storage and transmission management of the electrical energy transmitted from the power line; and said control/management system is connected to other existing large-scale power generation systems to establish a larger area energy application system.

10. The power station system according to claim 1, wherein, said power-generating units with a photovoltaic power-source unit or a wind-photovoltaic integrated power-source unit are distributed freely-spaced along both sides of urban roads and on clearing fields.

11. The power station system according to claim 2, wherein, said power-source-unit controller further includes a communication module on the basis of the intelligent control module, and the communication module intercommunicates with the control/management system.

12. The power station system according to claim 3, wherein, said power-source-unit controller further includes a communication module on the basis of the intelligent control module, and the communication module intercommunicates with the control/management system.

13. The power station system according to claim 4, wherein, said power-source-unit controller further includes a communication module on the basis of the intelligent control module, and the communication module intercommunicates with the control/management system.
